(19) United States
(12) Patent Application Publication
(10) Pub. No.: US 2014/0337905 A1
(43) Pub. Date: Nov. 13, 2014

(54) SYSTEM AND METHOD FOR DELIVERING EXTENDED MEDIA CONTENT

(71) Applicant: TELEFONAKTIEBOLAGET L M ERICSSON (PUBL), Stockholm (SE)

(72) Inventors: Chris Phillips, Hartwell, GA (US); Robert Hammond Forsman, Sugar Hill, GA (US); Jennifer Ann Reynolds, Duluth, GA (US); Charles Hammett Dasher, Lawrenceville, GA (US)

(73) Assignee: Telefonaktiebolaget L M Ericsson (PUBL), Stockholm (SE)

(21) Appl. No.: 13/890,401

(22) Filed: May 9, 2013

(51) Int. Cl. H04N 21/433; H04N 21/643; H04N 21/4147

(52) U.S. Cl. CPC H04N 21/4334; H04N 21/4147; H04N 21/64322
USPC 725/92

(57) ABSTRACT

A system and method for identifying and delivering extended media content. An extended content system receives requests to record or play identified broadcast content. The extended content system automatically obtains or preserves extended media content related to the identified broadcast content. In some instances, the system informs a subscriber that extended media content is available. If requested by the subscriber, the extended content system obtains the identified broadcast content and extended media content and provides the same to the subscriber in either a Set-Top-Box format or an Over-The-Top format.

### TECHNICAL FIELD

The disclosure relates generally to the delivery of media content. More particularly, but not by way of limitation, the disclosure is directed to a system and method for delivering broadcast and extended media content associated therewith.

### BACKGROUND

Video-On-Demand (VOD) includes the provisioning of video media content to subscribers. In some instances, video media content that is broadcast on television is tailored to fit in a broadcast time slot. Additionally, broadcast content is available in VOD formats, where subscribers may download the broadcast content to a personal video recorder, which may be located either locally with the subscriber, or remotely from the subscriber on a network. Network-based personal video recorders are commonly utilized in Internet Protocol Television (IPTV) systems. Broadcast content may also be provisioned through other delivery networks, such as Content Delivery Networks (CDNs). The type of network utilized to deliver content may be determined, in part, by the device utilized by the subscriber. For example, if the subscriber utilizes a Set-Top-Box (STB) device, the broadcast content may be formatted for such a device. Similarly, broadcast content may be formatted for other types of devices, such as Over-The-Top (OTT) devices. Exemplary OTT devices include, but are not limited to, cellular telephones, videogame systems, and other mobile computing devices.

Broadcast content may include one or more types of additional or associated content, also referred to as extended media content. This extended media content may include, for example, outtakes edited from the final version of the content, behind-the-scenes content, interviews with actors and production personnel, bloopers, and other bonus materials that are either edited out or not included with the broadcast content. In some embodiments, the extended media content may be excluded from the content so as to allow the broadcast content to fit within its broadcast time slot. In other embodiments, the broadcast content and extended media content include media content having any runtime duration (not constrained by broadcast time slot limitations). That is, the broadcast content and the extended media content are not created to fit within a broadcast time slot. Such types of content would include movies or other video content having run times that are not tailored to fit within a broadcast time slot.

In some instances, the extended media content is accessible on a content provider network. Subscribers are required to navigate to the content provider network to obtain the extended media content.

### SUMMARY

The present disclosure provides a system and method for identifying and delivering extended media content, along with identified broadcast content to which the extended media content relates.

One embodiment of the present disclosure provides a method for providing extended media content to a subscriber. Generally, the method is executed by an extended content system within a network. In one embodiment, the method includes receiving a request from the subscriber requesting the network to record identified broadcast content. Also, the method includes locating extended media content related to the identified broadcast content. It will be understood that the extended media content is stored in one or more locations in the network. The method also includes requesting transcoding of the extended media content and of the identified broadcast content, if necessary, for a client device of the subscriber. In one embodiment, the method includes exporting the identified broadcast content and the transcoded extended media content to a network personal video recorder for retrieval by the subscriber utilizing the client device.

In one embodiment, the extended media content includes at least one of: outtakes from the identified broadcast content; additional broadcast content cut from the identified broadcast content to permit broadcasting of the identified broadcast content within a given time period; behind-the-scenes content generated during preparation of the identified broadcast content; and interviews with actors in the identified broadcast content or crew members engaged in preparation of the identified broadcast content.

One embodiment of the present disclosure provides a method performed by an extended content system in a network for providing extended media content to a subscriber. The method includes receiving a request from the subscriber requesting the network to determine whether extended media content related to identified broadcast content exists. Also, the method includes determining whether the extended media content is present in a network datastore. It will be understood that upon determining that the extended media content is present in the network datastore, the method includes preserving the extended media content in the network datastore for the subscriber so as to prevent expiration of the extended media content in the network datastore.

It will be also understood that upon determining that the extended media content is not present in the network datastore, the method further includes querying a content provider system to locate the extended media content. Also, the method includes receiving a locator indicative of a location of the extended content on the content provider system.

In one embodiment, the method further includes querying the content provider system to determine whether the extended media content is available. Additionally, the method includes receiving from the content provider system, a confirmation that the extended content is available. The method also includes transmitting a prompt to the client device that the identified broadcast content includes the extended media content.

In one embodiment, the method further includes requesting an over-the-top backend system to generate a manifest for the identified broadcast content and the extended media content, as well as exporting the manifest to a client device of the subscriber.

One embodiment of the present disclosure provides an extended content system within a network for providing extended media content to a subscriber. The extended content system includes a processor and a memory coupled to the processor for storing computer program instructions. In one embodiment, the extended content system configured to receive request from the subscriber requesting the network to record identified broadcast content. Also, the extended content system is configured to locate extended media content related to the identified broadcast content, the extended media content being stored in one or more locations in the network. Additionally, the extended content system is configured to request transcoding of the extended media content and of the identified broadcast content, if necessary, for a client device of the subscriber. The extended content system is configured to export the identified broadcast content and the transcoded extended media content to a network personal video recorder for retrieval by the subscriber utilizing the client device.

One embodiment of the present disclosure provides an extended content system within a network for providing extended media content to a subscriber. The extended content system includes a processor and a memory coupled to the processor for storing computer program instructions. In one embodiment, the extended content system configured to receive a request from the subscriber requesting the network to determine whether extended media content related to identified broadcast content exists. The extended content system is also configured to determine whether the extended media content is present in a network datastore. Upon determining that the extended media content is present in the network datastore, the extended content system is configured to preserve the extended media content in the network datastore for the subscriber so as to prevent expiration of the extended media content in the network datastore.

One embodiment of the present disclosure provides a method performed by an extended content system in a network for providing extended media content to a subscriber. The method includes receiving a request from the subscriber requesting the network to play recorded broadcast content. The method also includes determining whether extended media content for the recorded broadcast content is present on a location within the network. Also, the method includes transmitting a prompt to the subscriber that the extended media content is available for the identified broadcast content, as well as receiving a request to obtain the identified broadcast content and the extended media content.

### BRIEF DESCRIPTION OF THE DRAWINGS

Certain embodiments of the present technology are illustrated by the accompanying figures. It will be understood that the figures are not necessarily to scale and that details not necessary for an understanding of the technology or that render other details difficult to perceive may be omitted. It will be understood that the technology is not necessarily limited to the particular embodiments illustrated herein.

FIG. 1A is a schematic diagram of a STB content delivery network in which embodiments of the present technology may be practiced;

FIG. 1B is a schematic diagram of an over-the-top content delivery network in which embodiments of the present technology may be practiced;

FIG. 1C is a schematic diagram of an exemplary extended content system;

FIG. 2 is a flowchart of an exemplary method of providing extended media content in response to a request to record broadcast content;

FIG. 3A is a flowchart of an exemplary method for determining the existence and/or location of extended media content;

FIG. 3B is a flowchart of an exemplary method for informing a subscriber that extended media content is available for requested broadcast content;

FIG. 4 is a flowchart of an exemplary method of pulling and storing extended media content from a content provider system:

FIG. 5 is a flowchart of an exemplary method of exporting a manifest for identified broadcast content and extended media content;

FIG. 6 is a flowchart of an exemplary method of providing extended media content of a STB device, in response to a request to play identified broadcast content; and

FIG. 7 is a flowchart of an exemplary method of providing extended media content to an OTT device, in response to a request to play identified broadcast content.

### DETAILED DESCRIPTION

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated.

It will be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Generally, the present technology is directed to the provisioning of extended media content to subscribers. More specifically, but not by way of limitation, the present technology provides a system and method for delivering extended media content to both Set-Top-Box (STB) devices and Over-The-Top (OTT) devices.

The present technology may provide extended media content, which is defined as additional media content that is associated with an instance of identified broadcast content. Exemplary types of extended media content include, but are not limited to, outtakes from the identified broadcast content; additional broadcast content cut from the identified broadcast content to permit broadcasting of the identified broadcast content within the given time period; behind-the-scene content generated during preparation of the identified broadcast content; and interviews with actors in the identified broadcast content or crew members engaged in preparation of the identified broadcast content. The extended media content may be stored on a network. By way of non-limiting example, the content may be stored on a network datastore, a network file store associated with a content management system, and also a content provider system.

The present technology allows for identification and retrieval of extended media content upon a subscriber requesting the recording or playback of identified broadcast content.

FIG. IA illustrates an exemplary Set-Top-Box (STB) content delivery network 100A for delivering identified broadcast content and extended media content to a subscriber. Broadcast content may be identified using a broadcast content identifier that allows the network 100A to uniquely identify an instance of broadcast content. In accordance with the present disclosure, this unique identifier also ties the broadcast content to extended media content.

Generally, the network 100A comprises an extended content system 105, client device 110, a network personal video recorder (NPVR) 115, a network datastore 120, an Internet protocol television (IPTV) network 130, a STB broadcast system 135, a content provider system 140, a content management system 145, and a network file store 150.

The client device 110 is associated with a subscriber (not shown) who interacts with the NPVR 115 through the IPTV network 130. The client device 110 may include any STB device that would be known to one of ordinary skill in the art. The client device 110 may couple with the IPTV network 130 via a private and/or public network such as the Internet.

The NPVR 115 receives requests to record or play broadcast content from the client device 110. The NPVR 115 also coordinates the recording and/or delivery of identified broadcast content to the client device 110 in response to these requests. The NPVR 115 stores recorded content for the subscriber in the network datastore 120. Although not show, the NPVR 115 may comprise a NPVR pump that is positioned between the IPTV network 130 and the NPVR 115.

In accordance with the present technology, the NPVR 115 forwards these requests from the client device 110 to the extended content system 105 for additional consideration. In general, when the extended content system 105 receives a request to record broadcast content from the client device 110, the extended content system 105 may automatically identify and obtain extended media content for the identified broadcast content. In other instances, the extended content system 105 may identify the availability of extended media content and inform the subscriber of the availability of the extended media content.

In some embodiments, the extended content system 105 may query and obtain extended media content from the content provider system 140. It is noteworthy that the extended media content may be stored on the network datastore 120 when the extended media content is downloaded from the content provider system 140 during recording of the identified broadcast content.

The extended content system 105 may cause the transcoding and delivery of extended media content in STB formats. More specifically, the extended content system 105 causes the content management system 145 to format identified broadcast content and any requested (or automatically obtained) extended media content in a format that is suitable for broadcasting by the STB broadcast system 135. In some embodiments, content may be transcoded and formatted for delivery via the IPTV network 130. Additionally, the content may be transcoded and formatted in accordance with the requirements of the client device 110. It will be understood that not all identified broadcast content and/or extended media content will require transcoding.

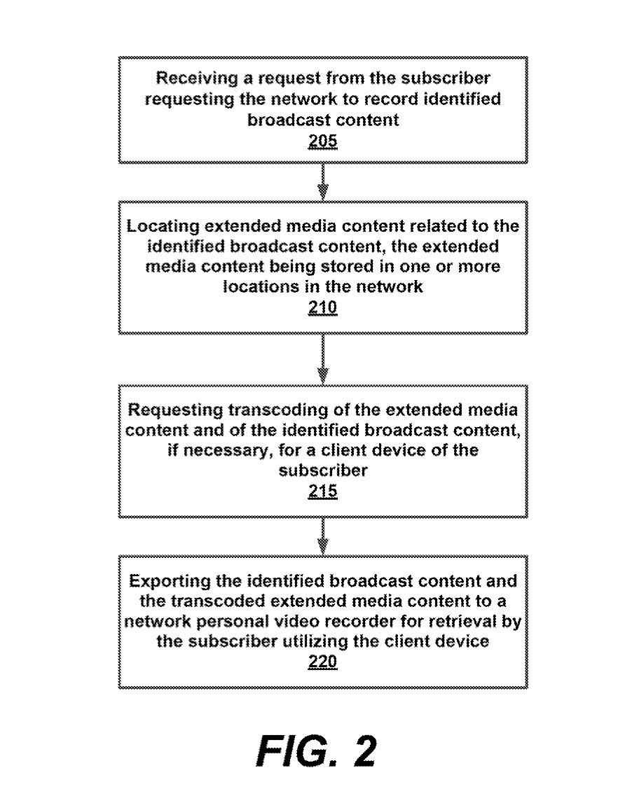

In some embodiments, the content management system 145 may perform the transcoding of identified broadcast content and extended media content. In exemplary methods, the extended content system 105 may pull identified broadcast content and extended media content from the content provider system 140 and store the same in the network file store 150. The content management system 145 transcodes the identified broadcast content and extended media content and stores the transcoded content in network file store 150. Additional details regarding the delivery of identified broadcast content and extended media content will be described below with reference to the flowcharts of FIGS. 2-7.

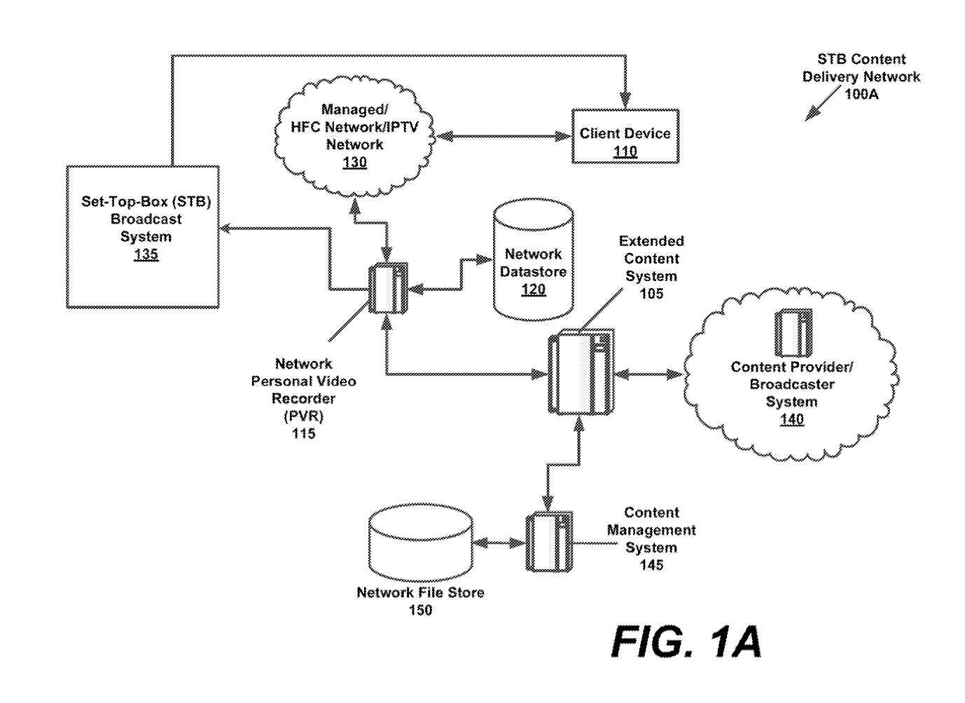

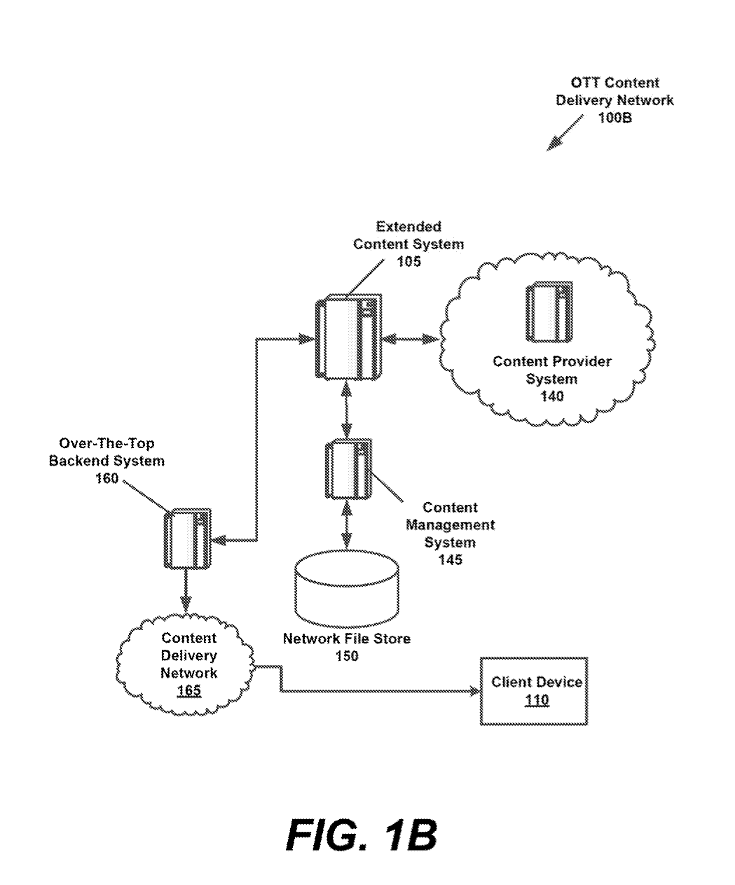

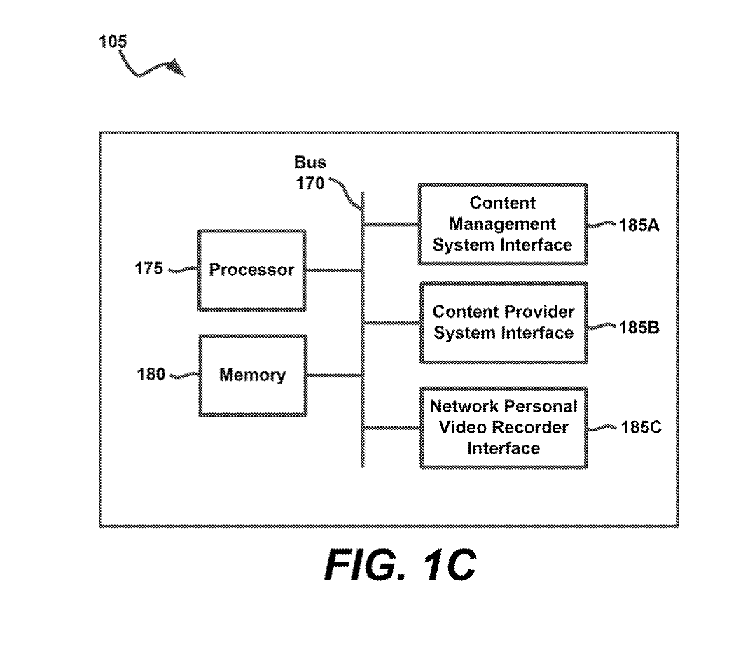

FIG. 1B illustrates an exemplary over-the-top content delivery network 100B for delivering identified broadcast content and extended media content to a subscriber. Generally, the network 100B comprises the extended content system 105, the content provider system 140, the content management system 145, and the network file store 145 as described in the network 100A of FIG. 1A.

In contrast with the network 100A of FIG. 1A, the network 100B of FIG. 1B includes an Over-The-Top (OTT) backend system 160 and a content delivery network 165. The OTT backend system 160 and the content delivery network 165 cooperate to provide identified broadcast content and extended media content to the client device 110 in an over-the-top format. Exemplary client devices that utilize over-the-top formats include, but are not limited to, mobile computing devices, such as tablets, laptops, and other similar computing devices. Other exemplary over-the-top devices include video game consoles and cellular telephones. Again, additional details regarding the delivery of extended media content will be described below with reference to the flowcharts of FIGS. 2-7.

One of ordinary skill in the art will appreciate that the respective networks 100A and 100B of FIGS. 1A and 1B may be combined into a single system, as is common with multi-system operator (MSO) systems, where a single entity provides STB and OTT content to subscribers via a plurality of delivery means.

FIG. 1C is a schematic diagram of the extended content system 105 of FIGS. 1A and 1B. In general, the extended content system 105 comprises a plurality of components that are communicatively coupled via a bus 170. The extended content system 105 comprises a processor 175 and a memory 180 for storing executable instructions. The executable instructions, when executed by the processor 175, enable the processor to perform the methods described in the flowcharts of FIGS. 2-7. The processor 175 can be implemented as at least one microprocessor with one or more processing cores. The processor 175 can be implemented as a core processor that services one or more of the components of the extended content system 105.

Additionally, the extended content system 105 comprises various interfaces for interacting with the networks 100A and 100B of FIGS. 1A and 1B respectively. Exemplary interfaces include a content management system interface 185A, a content provider system interface 185B, and a network personal video recorder interface 185C.

It will be understood that the extended content system 105 may be a dedicated server or other computing node that is made accessible within the systems 100A and 100B. Moreover, for the purposes of brevity, ancillary details of the extended content system 105 which are not directly implicated in providing features of the present technology have been omitted from discussion, although these features would be known to one of ordinary skill in the art with the present disclosure before them.

Turning now to various exemplary methods executed by the extended content system 105, FIG. 2 illustrates a method for delivering extended media content. This method contemplates the delivery of extended media content upon receiving 205 a request to record identified broadcast content. The request is received by the extended content system 105 from the NPVR 115 that services the client device 110 issuing the request. The broadcast content is requested or identified by the client device 110 using broadcast content identification methodologies that would be known to one of ordinary skill in the art.

This method further includes locating 210 extended media content for the identified broadcast content, where the extended media content being stored in one or more locations in the network 100A, such as within the network datastore 120. It will be understood that in this method, the extended content system 105 automatically locates extended media content. In some methods, the extended content system 105 will prompt the subscriber that extended media content is available before obtaining the extended media content from the content provider system 140.

After locating extended media content, the method includes requesting 215 transcoding of the extended media content and of the identified broadcast content, if necessary, for a client device of the subscriber. In detail, the extended content system 105 obtains the broadcast content and the extended media content from a location on the network 100A and transmits the same to a content management system 145. The content management system 145 may transcode the broadcast content and the extended media content.

With regard to STB devices, the transcoding may comprise generating a representation of the broadcast content that includes metadata referencing the location or position of extended media content in the broadcast content. For example, the metadata may define where in the broadcast content the extended media content is positioned, such as the beginning or at the end of the broadcast content. Indeed, some extended media content may be interleaved within the broadcast content. The transcoding of the content by the content management system 145 formats the broadcast content and metadata for use by a STB device.

After transcoding and/or storing of the transcoded content, the method further includes exporting the identified broadcast content and the transcoded extended media content to a network personal video recorder 115 for retrieval by the subscriber utilizing the client device. More specifically, the extended content system 105 may transmit the transcoded broadcast content from the network file store 150 to the NPVR 115. The NPVR 115 then stores the transcoded broadcast content in the network datastore 120.

In some instances, exporting of the identified broadcast content and the transcoded extended media content includes sending metadata associated with the extended media content to the network personal video recorder 115. Transcoded content may be rendered on the client device 110. During playback of the broadcast content, the metadata allows the NPVR 115 to obtain extended media content from the network datastore 120 and present the same to the client device 110.

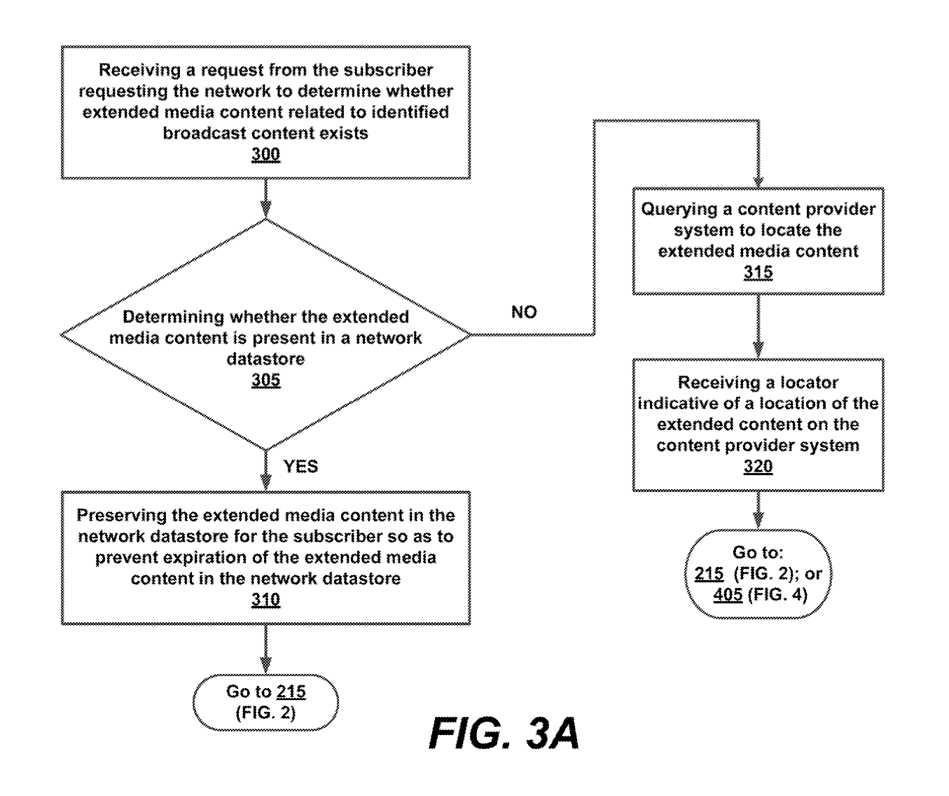

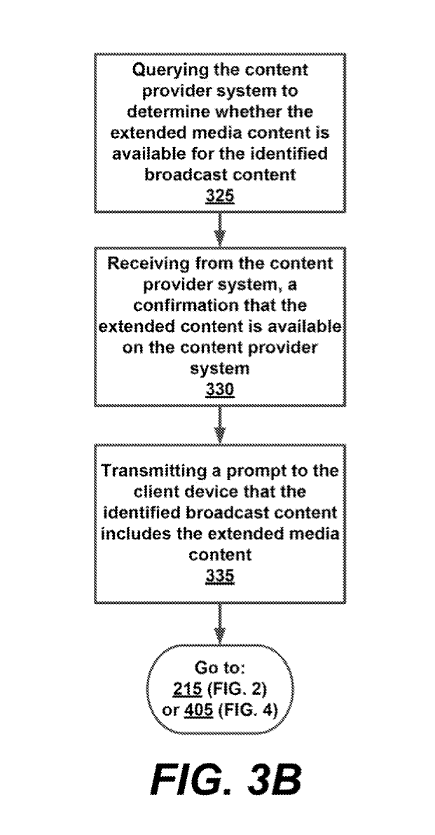

FIG. 3A is a flowchart of a method for determining the existence and/or location of extended media content. It will be understood that in some embodiments, instead of automatically obtaining extended media content, the extended content system 105 may be configured to determine if extended media content exists.

In some instances, the method includes receiving 300 a request from the subscriber requesting the network to determine whether extended media content related to identified broadcast content exists. It will be understood that the request to obtain extended media content may be received by the extended content system 105 from a client device 110 upon a request to record or playback broadcast content. In some embodiments, the step of receiving 300 is an optional step, such as when the extended content system 105 informs the subscriber that extended media content is available.

The extended content system 105 may execute a step of determining 305 if the extended media content is present in the network datastore 120 associated with the NPVR 115. It is noteworthy that the extended content system 105 may execute the step of determining in both automatic downloading and subscriber requested downloading of extended media content. Thus, in some instances, the step of receiving 300 the request for extended media content may not be required, allowing the method to being at step 305.

The step of determining 305 may include the extended content system 105 interrogating the NPVR 115 for extended media content stored in the network datastore 120. If extended media content is found in the network datastore 120, the method includes preserving 310 the extended media content in the network datastore 120 so as to prevent expiration of the extended media content on the network datastore 120. In detail, the extended content system 105 may inform the NPVR 115 to identify the extended media content as being requested for the subscriber, thus preventing NPVR 115 from deleting the requested content. Various policies and procedures may be established for keeping broadcast content and any associated extended media content on the network datastore 120.

In some instances, the method may return to step 210 of FIG. 2, for example, when the extended content system 105 automatically obtains and preserves extended media content upon a request to record identified broadcast content. Indeed, the subscriber may initially issue a request to the extended content system 105 that all requests to record broadcast content are to include a request to obtain and preserve extended media content for the subscriber.

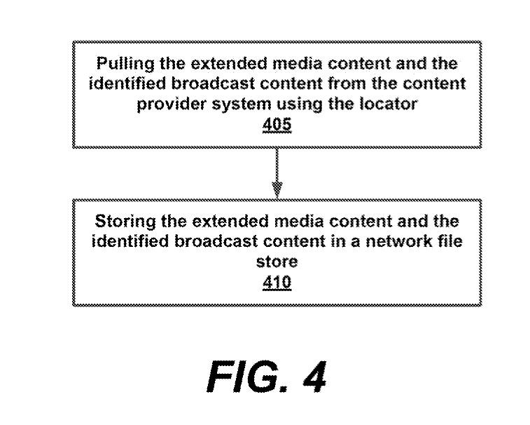

If the extended content system 105 determines that no extended media content for the request exists in the network datastore 120, the method includes querying 315 a content provider system to locate the extended media content for the broadcast content. The method may return to step 215 of the method of FIG. 2, where transcoding occurs. Alternatively, the method may go to a step 405 (see FIG. 4) of pulling the extended media content from the content provider system 140, as will be discussed in greater detail below.

FIG. 3B is a flowchart of a method for informing a subscriber that extended media content is available for identified broadcast content. The method includes querying 325 the content provider system 140 to determine if extended media content is available for the identified broadcast content. In some instances, querying may include providing a broadcast content identifier to the content provider system 140. As mentioned above, the broadcast content identifier allows the content provider system 140 uniquely identify broadcast content. This unique identifier ties the broadcast content to extended media content.

Also, the method includes receiving 330 a confirmation that the extended media content is available on the content provider system 140, as well as transmitting 335 a prompt to the client device 110 that the broadcast content comprises extended media content. Again, the extended content system 105 transmits a signal to the NPVR 115 that extended media content exists for the identified broadcast content. It is noteworthy that the method may return to step 215 of FIG. 2 or may proceed to step 405 of FIG. 4, which will be described in greater detail next.

FIG. 4 is a flowchart of a method of pulling and storing extended media content. More specifically, the method includes pulling 405 the extended media content and the broadcast content from the content provider system 140. This method may include using the locator obtained by the extended content system 105. Extended media content may be pulled by the extended content system 105 from the content provider system 140 using this broadcast content identifier. The method also includes storing 410 the extended media content and the broadcast content in a network file store 150. More specifically, the extended content system 105 transmits the pulled extended media content to the content management system 145. The content management system 145 stores the extended media content and the broadcast content in the network file store 150. This step occurs prior to a step of transcoding of the broadcast content, which may include any of the transcoding steps of the methods of FIGS. 2, 5, and 6.

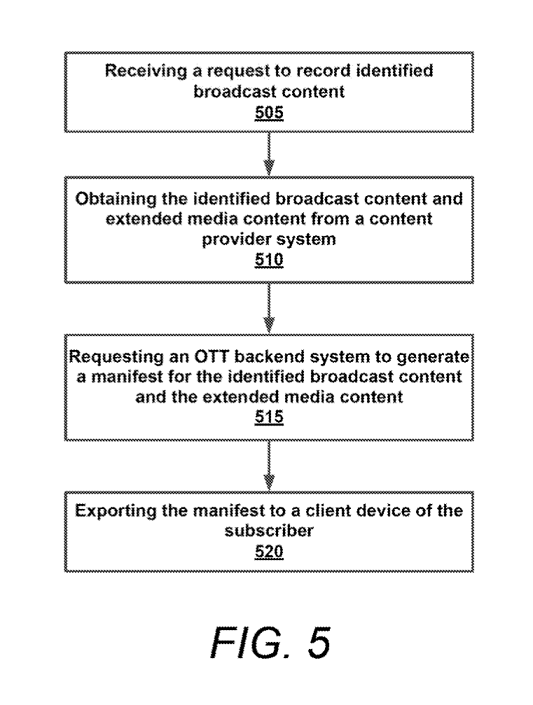

FIG. 5 illustrates a method of exporting a manifest for identified broadcast content and extended media content. More specifically, the method of FIG. 5 relates to the provisioning of extended media content to OTT devices by the extended content system 105. The method includes a step of receiving 505 a request to record broadcast content. Next, the method includes receiving 510 the broadcast content and extended media content from the content provider system 140.

Therefore, the method includes a step 515 of requesting an OTT backend system 160 to generate a manifest for the broadcast content and the extended media content to an OTT backend system 160. In some instances, the OTT backend system 160 exports the manifest to the client device 110. Also, the method includes exporting 520 the manifest to a client device of the subscriber.

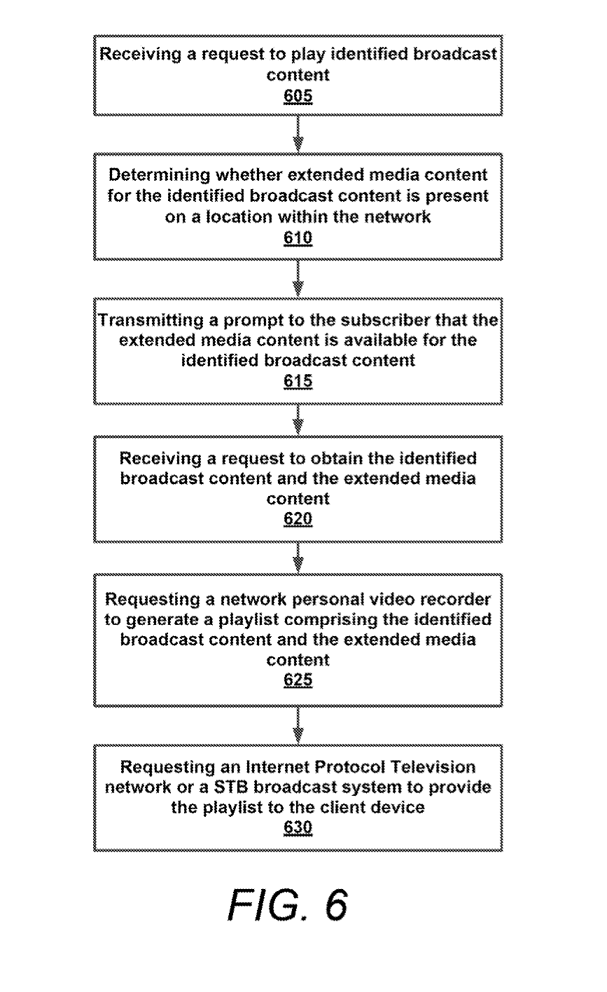

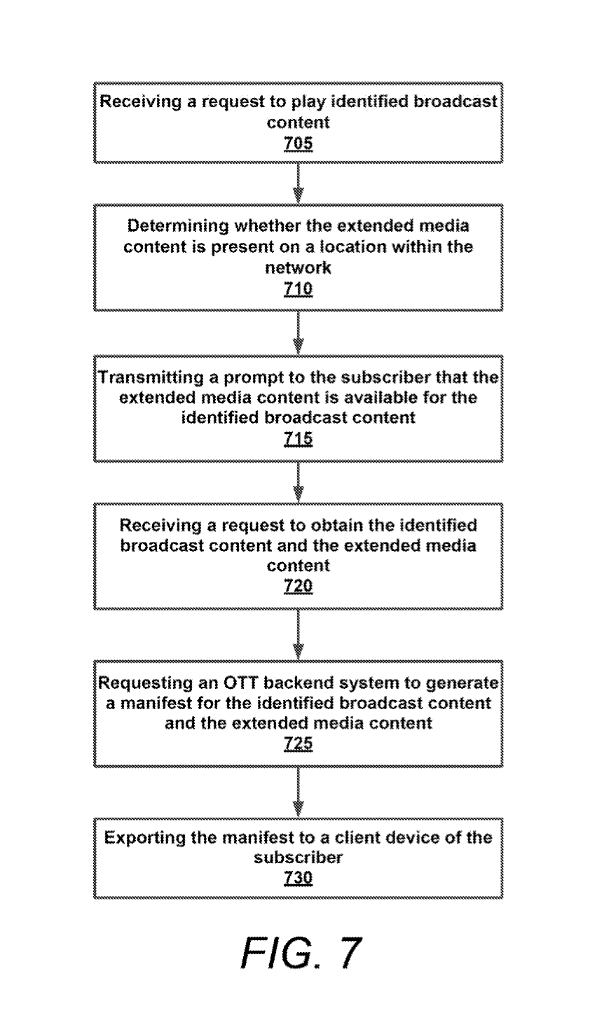

FIGS. 6 and 7 collectively illustrate methods for providing extended media content to a client device 110 upon the extended content system 105 receiving a request to play broadcast content. The method of FIG. 6 is directed to a process of providing extended media content to a STB client device and the method of FIG. 7 is directed to a process of providing extended media content to an OTT client device.

The method of FIG. 6 includes a step 605 of receiving a request to play broadcast content. It will be understood that this method contemplates a request to play already-recorded broadcast content. The method includes a step 610 of determining whether extended media content for the recorded broadcast content is present on a location within the network. That is, the extended content system 105 may be configured to examine various network locations such as the network datastore 120, the network file store 105 associated with the content management system 145, and/or the content provider system 140 to determine if any extended content is available for the identified broadcast content. Next, the method includes transmitting a prompt to the subscriber that the extended media content is available for the identified broadcast content. That is, the extended content system 105 informs the client device 110 that extended media content is available. Next, the method includes receiving 620 a request to obtain the extended media content and the broadcast content.

In some embodiments, the method further includes requesting the NPVR 115 to generate a playlist comprising the broadcast content and the extended media content. Next, the method comprises requesting 625 an IPTV network 130 or a STB broadcast system 135 to provide the playlist to the client device 110.

With regard to FIG. 7, the method includes steps 705-720, which are similar to steps 605-620 of FIG. 6. Additionally, the method of FIG. 7 includes requesting 725 an over-the-top backend system 160 to generate a manifest for the extended media content and the identified broadcast content, as well as a step of exporting 730 the manifest to a client device 110 of the subscriber.

It is noteworthy that any hardware platform suitable for performing the processing described herein is suitable for use with the systems and methods provided herein. Computer-readable storage media refer to any medium or media that participate in providing instructions to a central processing unit (CPU), a processor, a microcontroller, or the like. Such media may take forms including, but not limited to, non-volatile and volatile media such as optical or magnetic disks and dynamic memory, respectively. Common forms of computer-readable storage media include a floppy disk, a flexible disk, a hard disk, magnetic tape, any other magnetic storage medium, a CD-ROM disk, digital video disk (DVD), any other optical storage medium, RAM, PROM, EPROM, a FLASHEPROM, any other memory chip or cartridge.

Computer program code for carrying out operations for aspects of the present technology may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be coupled with the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

Embodiments of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While various embodiments have been described above, it should be understood that they have been presented by way of example only, and not limitation. The descriptions are not intended to limit the scope of the technology to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the technology as defined by the appended claims and otherwise appreciated by one of ordinary skill in the art. The scope of the technology should, therefore, be determined not with reference to the above description, but instead should be determined with reference to the appended claims along with their full scope of equivalents.

1. A method in a network for providing extended media content to a subscriber, wherein the method is performed by an extended content system and comprises:
receiving a request from the subscriber requesting the network to record identified broadcast content;
locating extended media content related to the identified broadcast content, the extended media content being stored in one or more locations in the network;
requesting transcoding of the extended media content and of the identified broadcast content, if necessary, for a client device of the subscriber; and
exporting the identified broadcast content and the transcoded extended media content to a network personal video recorder for retrieval by the subscriber utilizing the client device.

2. The method according to claim 1, wherein the extended media content includes at least one of:
outtakes from the identified broadcast content;
additional broadcast content cut from the identified broadcast content to permit broadcasting of the identified broadcast content within a given time period;
behind-the-scenes content generated during preparation of the identified broadcast content; and
interviews with actors in the identified broadcast content or crew members engaged in preparation of the identified broadcast content.

3. The method according to claim 1, wherein the exporting also includes sending metadata associated with the extended media content to the network personal video recorder.

4. The method according to claim 1, wherein the client device comprises a Set-Top-Box device.

5. A method performed by an extended content system in a network or providing extended media content to a subscriber, the method comprising:
receiving a request from the subscriber requesting the network to determine whether extended media content related to identified broadcast content exists;
determining whether the extended media content is present in a network datastore; and
upon determining that the extended media content is present in the network datastore, preserving the extended media content in the network datastore for the subscriber so as to prevent expiration of the extended media content in the network datastore.

6. The method according to claim 5, further comprising upon determining that the extended media content is not present in the network datastore:
querying a content provider system to locate the extended media content; and
receiving a locator indicative of a location of the extended content on the content provider system.

7. The method according to claim 6, further comprising:
querying the content provider system to determine whether the extended media content is available;
receiving from the content provider system, a confirmation that the extended content is available on the content provider system; and
transmitting a prompt to the client device that the identified broadcast content includes the extended media content.

8. The method according to claim 7, further comprising:
pulling the extended media content and the identified broadcast content from the content provider system using the locator; and
storing the extended media content and the identified broadcast content in a network file store.

9. The method according to claim 5, further comprising:
requesting an over-the-top backend system to generate a manifest for the identified broadcast content and the extended media content; and
exporting the manifest to a client device of the subscriber.

10. The method according to claim 9, wherein the client device comprises an Over-The-Top device.

11. The method according to 5, further comprising:
requesting a network personal video recorder to generate a playlist comprising the identified broadcast content and the extended media content; and
requesting an Internet Protocol Television network or a Set-Top-Box broadcast system to provide the playlist to the client device.

12. The method according to claim 11, wherein the extended media content includes at least one of:
outtakes from the identified broadcast content;
additional broadcast content cut from the identified broadcast content to permit broadcasting of the identified broadcast content within a given time period;
behind-the-scenes content generated during preparation of the identified broadcast content; and
interviews with actors in the identified broadcast content or crew members engaged in preparation of the identified broadcast content.

13. An extended content system within a network for providing extended media content to a subscriber, the extended content system comprising:
a processor;
a memory coupled to the processor for storing computer program instructions, the extended content system configured to:
receive a request from the subscriber requesting the network to record identified broadcast content;
locate extended media content related to the identified broadcast content, the extended media content being stored in one or more locations in the network;
request transcoding of the extended media content and of the identified broadcast content, if necessary, for a client device of the subscriber; and
export the identified broadcast content and the transcoded extended media content to a network personal video recorder for retrieval by the subscriber utilizing the client device.

14. The system according to claim 13, wherein the extended media content includes at least one of:
outtakes from the identified broadcast content;
additional broadcast content cut from the identified broadcast content to permit broadcasting of the identified broadcast content within a given time period;
behind-the-scenes content generated during preparation of the identified broadcast content; and
interviews with actors in the identified broadcast content or crew members engaged in preparation of the identified broadcast content.

15. The system according to claim 13, wherein the extended content system is configured to send metadata associated with the extended media content to the network personal video recorder.

16. The system according to claim 13, wherein the client device comprises a Set-Top-Box device.

17. An extended content system in a network for providing extended media content to a subscriber, the extended content system comprising:
a processor;
a memory coupled to the processor for storing computer program instructions, the extended content system configured to:
receive a request from the subscriber requesting the network to determine whether extended media content related to identified broadcast content exists;
determine whether the extended media content is present in a network datastore; and
upon determining that the extended media content is present in the network datastore, preserve the extended media content in the network datastore for the subscriber so as to prevent expiration of the extended media content in the network datastore.

18. The system according to claim 17, wherein upon the network determining that the extended media content is not present in the network datastore, the extended media content system is further configured to:
query a content provider system to locate the extended media content; and
receive a locator indicative of a location of the extended content on the content provider system.

19. The system according to claim 18, wherein the extended media content system is further configured to:
query the content provider system to determine whether the extended media content is available;
receive from the content provider system, a confirmation that the extended content is available; and
transmit a prompt to the client device that the identified broadcast content includes the extended media content.

20. The system according to claim 19, wherein the extended media content system is further configured to:
pull the extended media content and the identified broadcast content from the content provider system using the locator; and
store the extended media content and the identified broadcast content in a network file store.

21. The system according to claim 17, wherein the extended media content system is further configured to:
request an over-the-top backend system to generate a manifest for the identified broadcast content and the extended media content; and
export the manifest to a client device of the subscriber.

22. The system according to claim 21, wherein the client device comprises an Over-The-Top device.

23. The system according to 17, wherein the extended media content system is further configured to:
request a network personal video recorder to generate a playlist comprising the identified broadcast content and the extended media content; and
request an Internet Protocol Television network or a Set-Top-Box broadcast system to provide the playlist to the client device.

24. A method in a network for providing extended media content to a subscriber, wherein the method is performed by an extended content system and comprises:
receiving a request from the subscriber requesting the network to play recorded broadcast content;
determining whether the extended media content is present on a location within the network;
transmitting a prompt to the subscriber that the extended media content is available for the identified broadcast content; and
receiving a request to obtain the identified broadcast content and the extended media content.

25. The method according to claim 24, further comprising requesting a network personal video recorder to generate a playlist comprising the identified broadcast content and the extended media content; and
requesting an Internet Protocol Television network or a Set-Top-Box broadcast system to provide the playlist to the client device.

26. The method according to claim 24, further comprising requesting an Over-The-Top backend system to generate a manifest for the identified broadcast content and the extended media content; and exporting the manifest to a client device of the subscriber.
